(19) United States
(12) Patent Application Publication
(10) Pub. No.: US 2014/0153381 A1
(43) Pub. Date: Jun. 5, 2014

(54) INFORMATION TRANSMISSION NETWORK AND CORRESPONDING NETWORK NODE

(71) Applicants: SYSTEMES EMBARQUES AEROSPATIAUX, Paris (FR); THALES, NEUILLY SUR SEINE (FR)

(72) Inventors: Alexis Dubrovin, Meudon La Foret Cedex (FR); Michel Francois Gueguen, Elancourt (FR); Augustin Mignot, Meudon La Foret (FR); Paul Ortais, Paris (FR)

(73) Assignees: SYSTEMES EMBARQUES AEROSPATIAUX, PARIS (FR); THALES, NEUILLY SUR SEINE (FR)

(21) Appl. No.: 14/233,776

(22) PCT Filed: Jul. 19, 2012
(86) PCT No.: PCT/EP2012/064223

§ 371 Date: Jan. 20, 2014

(30) Foreign Application Priority Data
Jul. 20, 2011 (FR) 11 02265

(51) Int. Cl. H04L 12/42

(52) U.S. Cl. CPC H04L 12/42
USPC 370/216; 370/389; 370/412; 370/328

(57) ABSTRACT

The network according to the invention, including functional nodes connected in series by information transmission means, in which the information assumes the form of discrete messages propagating from node to node in the network, is characterized in that the information transmission means between the nodes are bidirectional to allow information to propagate in both circulation directions of the network, and each node includes at least one first and second associated information input/output port, connected by corresponding information transmission means to neighboring nodes and the operation of which is controlled exclusively and sequentially, by means forming a communication automaton, between a mode of operation with asynchronous reception of information from its neighboring nodes and a mode of operation for synchronous transmission of information to its neighboring nodes.

### CROSS-REFERENCE TO RELATED APPLICATIONS

This application is the National Stage of International Application No. PCT/EP2012/064223 filed on Jul. 19, 2012. This application published as WO/2013/011101 on Jan. 24, 2013. The International Application claims priority to French Patent Application No. 11 02265 filed Jul. 20, 2011. All of the above applications are herein incorporated by reference.

### FIELD OF THE INVENTION

The present invention relates to an information transmission network and a corresponding network node.

More particularly, the invention relates to one such network that includes functional nodes connected in series by information transmission means, in which the information assumes the form of discrete messages propagating from node to node in the network.

### BACKGROUND

A data transmission method and device are already known from document FR A 2,857,805.

Such a method and system are for example implemented in a closed control computer system, for example on board an air or land vehicle.

The method described in this document describes a step for transmitting data point-to-point between two transmission nodes, for example via a wired network, each node having one or more channels each authorizing the transmission with a single node; a data conversion step for the transmission of that data, for example in series, and the computer of each of the nodes responds to the reception of a message with an unconditional transmission that propagates the information streams along closed chains, the data stream control then been determined implicitly by the cable topology used, and the transmission between nodes uses an asynchronous or isochronous mode.

While being based on the use of such a network in which functional nodes are connected in series using information transmission means, the invention seeks to optimize a number of features of these networks, for example reliability, throughput, failure mode coverage, etc.

### SUMMARY

To that end, examples of the invention relate to an information transmission network, of the type including functional nodes connected in series by information transmission means, in which the information assumes the form of discrete messages propagating from node to node in the network, characterized in that the information transmission means between the nodes are bidirectional to allow information to propagate in both circulation directions of the network, each node includes at least one first and second associated information input/output port, connected by corresponding information transmission means to neighboring nodes and the operation of which is controlled exclusively and sequentially, by means forming a communication automaton, between a mode of operation with asynchronous reception of information from its neighboring nodes and a mode of operation for synchronous transmission of information to its neighboring nodes.

According to other features of the network according to examples of the invention considered alone or in combination, the communication automaton can be suitable for switching the associated ports of the node from their reception operating mode to their transmission operating mode, after, for each of them:
either receiving valid information,
or the expiration of a predetermined period of time for non-reception of valid information.

The communication automaton can be suitable for switching each of the associated ports in return, from its transmission operating mode to its reception operating mode, after the end of transmission of the information by the port.

The ports associated with each node are connected to buffer-forming means using first in-first out logic. Nodes include more than two associated input/output ports. The nodes are connected in a closed loop using information transmission means. The nodes are connected by information transmission means, in at least one branch whereof the end nodes are suitable for operating in a mirror mode for returning information to the transmitting neighboring node. The nodes are connected by information transmission means, in a connecting branch of other nodes connected in the closed loop by information transmission means. Each node is suitable for switching into the mirror operating mode for returning information to a neighboring transmitting node in the event a malfunction is detected.

At least some of the nodes include means for generating service information intended to be transmitted over the network. At least some of the nodes include means for generating error information intended to be transmitted in case of non-reception of valid information from a neighboring node within a predetermined period of time.

The information transmission means can include a wired connection means. The information transmission means comprise pairs of twisted wires. The information transmission means include coaxial cables. The information transmission means include optical fibers. The information transmission means include wireless connection means.

According to another aspect, the invention also relates to a corresponding network node.

### BRIEF DESCRIPTION OF THE DRAWINGS

The invention will be better understood using the following description, provided solely as an example and done in reference to the appended drawings, in which:

FIG. 1 shows a block diagram illustrating the general structure of functional nodes connected in series in an information transmission network according to examples of the invention,

FIG. 2 shows a block diagram illustrating the general structure of one example embodiment of a node in the composition of a transmission network according to examples of the invention,

FIGS. 3 and 4 illustrate the general operating principle of an information transmission network according to examples of the invention,

FIG. 5 illustrates the switching of the operation of the node between its reception mode and its transmission mode,

FIG. 6 provides a detailed illustration of a register structure included in the composition of the node,

FIG. 7 illustrates the normal operation of a node in the composition of the network according to examples of the invention,

FIG. 8 shows a downgraded operating mode of the transmission network according to examples of the invention,

FIG. 9 shows the structure of a node including more than two information input and output ports,

FIG. 10 illustrates an example embodiment of a network formed from nodes, and

FIG. 11 illustrates an example embodiment of a message frame format used in a transmission network according to examples of the invention.

### DETAILED DESCRIPTION

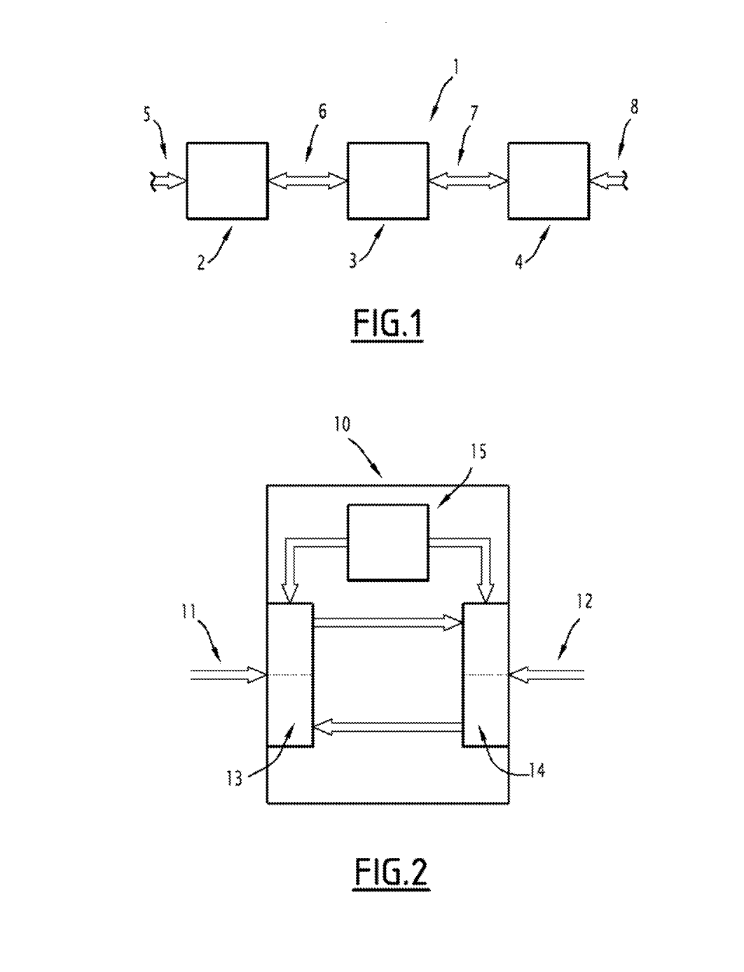

FIG. 1 shows one example embodiment of a portion of an information transmission network that includes functional nodes connected in series by information transmission means.

In this FIG. 1, the network is designated by general reference 1 and, in the described example, includes three nodes designated by references 2, 3 and 4, respectively.

These functional nodes are therefore connected in series by information transmission means for example designated by references 5, 6, 7 and 8, respectively.

These information transmission means may be based on wired transmission means for example formed by pairs of twisted wires or by coaxial cables or other means.

However, other embodiments may be considered, for example the use of optical fibers, or others, as well as wireless connecting means.

This network is then suitable for transmitting information that assumes the form of discrete messages propagating from node to node in the network.

In the transmission network according to the invention, the information transmission means between the nodes are bidirectional to allow information to propagate in both circulation directions of the network.

Such an operation is for example illustrated in FIGS. 2, 3 and 4.

FIG. 2 shows an example embodiment of a node included in the composition of such a network, that node being designated by general reference 10.

Said node is then for example connected by means of two information transmission means 11 and 12, respectively, to neighboring nodes in the network.

In fact, each node includes at least one first and second associated information input and output ports, designated by references 13 and 14, for example, in said FIG. 2, connected by the corresponding information transmission means 11 and 12 to the neighboring nodes in the network, respectively. The operation of these associated information input and output ports is then controlled sequentially and exclusively, using means forming a communication automaton designated by general reference 15, between a mode of operation with asynchronous reception of information from its neighboring nodes and a mode of operation for synchronous transmission of information to its neighbor nodes.

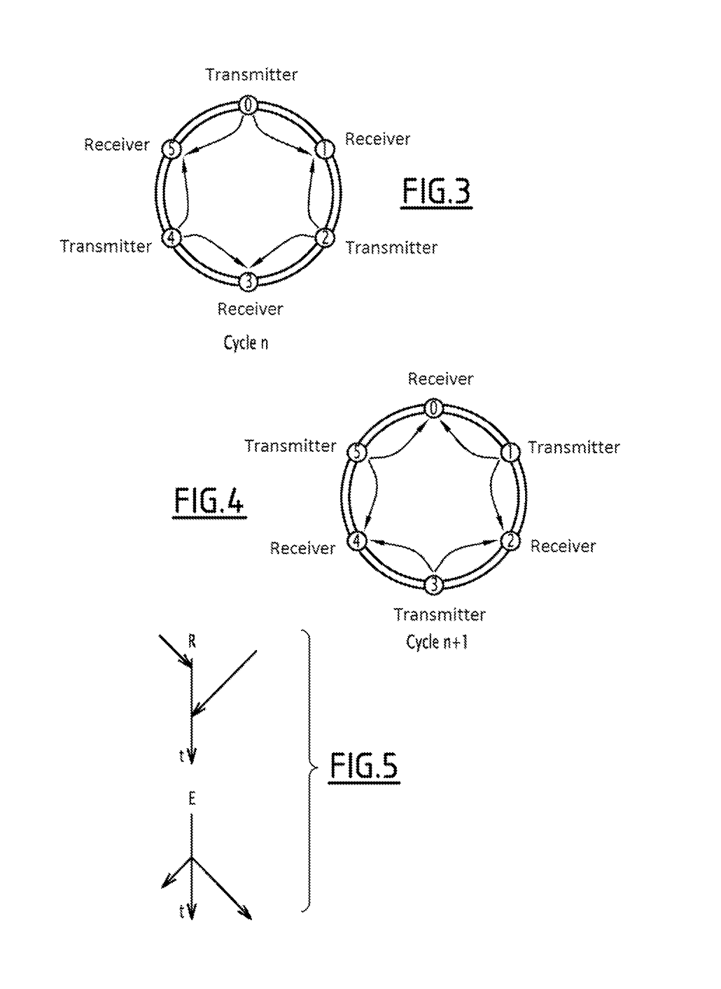

It is then possible to see that, related to a network like that illustrated in FIGS. 3 and 4, in which the nodes are for example connected in a closed loop, each node switches exclusively and sequentially between operation as an information transmitter to its neighboring nodes, which are then in the reception operating mode, and an operation in the reception mode receiving information from its neighbors, which are then in the transmission operating mode.

FIGS. 3 and 4 in fact illustrate two successive cycles n and n+1, allowing the nodes to transmit the information in the network.

In fact, and as illustrated in FIG. 5, for each node, the switching between the reception mode R and the transmission mode E is activated by the communication automaton once the corresponding node has received information from its neighbors. That is why the expression “mode of operation in asynchronous reception of information from its neighboring nodes” is used.

Once information is received from its neighbors, the communication automaton then switches the corresponding associated ports of the node to their transmission operating mode, all of the ports associated with the node then entering the mode for transmitting information to the neighboring nodes. The expression “mode of operation for synchronous transmission of information to the neighboring nodes” is then used.

In fact, the communication automaton is suitable for switching the set of ports associated with the node from their reception operating mode to their transmission operating mode after, for each of them, either the reception of valid information, or the expiration of a predetermined time period for non-reception of valid information.

In the other direction, the communication automaton is suitable for switching, in return, each of the associated ports from its transmission operating mode E to its reception operating mode R, after the end of transmission of the information by the port.

One can then see that this makes it possible to avoid any collision of messages on the information transmission means, inasmuch as neighboring nodes cannot transmit at the same time on the information transmission means connecting them to each other.

As indicated in the aforementioned prior art document, this makes it possible to avoid the use, in the nodes, of extremely cumbersome means for managing collisions on the network, which results in a very substantial simplification thereof.

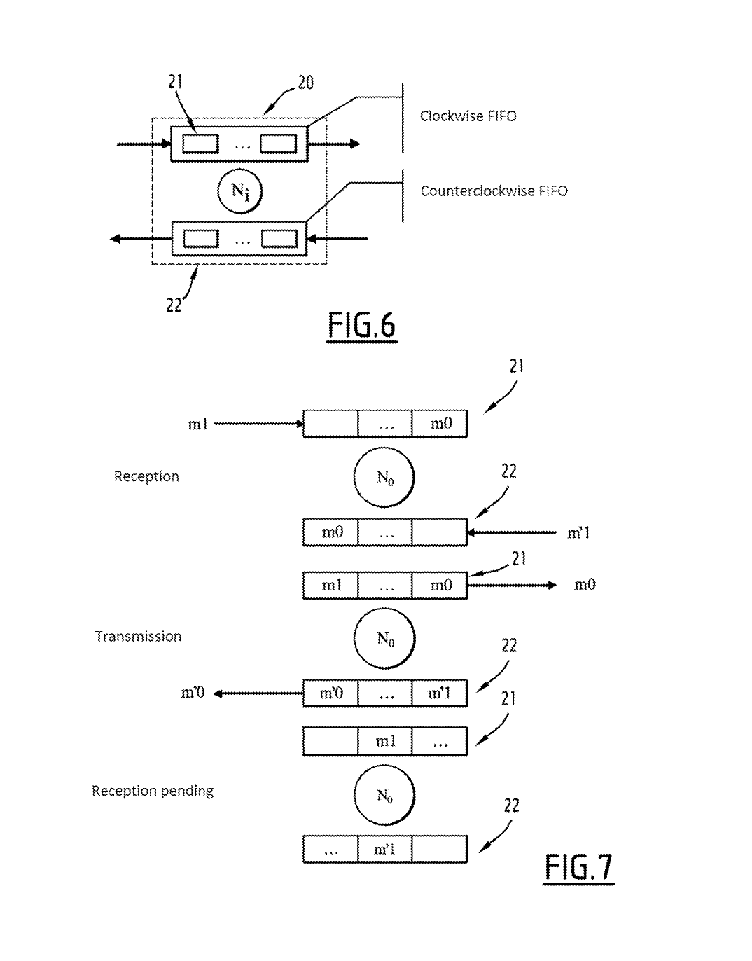

One example embodiment of such a node is illustrated in FIG. 6.

In fact, the node illustrated in that figure is designated by general reference 20, and the ports associated therewith for example comprise means in the form of FIFO (first-in-first-out) registers, mounted head-to-tail between the information transmission means connecting said node to its neighbors.

Of course, any other structure using buffer-forming means following first in-first out logic may also be used.

These FIFO register means are designated by general references 21 and 22.

One of these means then makes it possible to transmit information in one direction, and the other in the other direction of the network. These register-forming means in fact receive information from a node in order to transmit it by propagating it to the other node and vice versa.

The operation of such a node is illustrated in FIG. 7.

This figure shows the registers 21 and 22 previously described in their different operating states based on the state of the node being controlled by the communication automaton.

The first state, illustrated in the upper part of this figure, is the information receiving state of the node.

Each FIFO register-forming means 21, 22 already has a previously received message, designated m0 and m′0 for messages circulating in either direction of that network, in memory.

In the state illustrated in the upper part of the figure, the node is in the operating mode for receiving subsequent messages, for example messages m1 and m′1.

Once the two messages m1 and m′1 are received, the node, as previously described and under the control of the communication automaton, enters transmission mode for the previous messages, i.e., m0 and m′0, which are then sent to the corresponding neighboring nodes.

That state is illustrated in the middle part of FIG. 7.

In the lower part of FIG. 7, the messages m0 and m′0 have been transmitted, such that the node then goes into standby mode while awaiting reception of messages from its neighbors, and so forth.

It is then possible to see that the messages are placed in a queue and are transmitted when new messages are received.

As previously indicated, in the nominal operating case of that network, i.e., when all of the nodes and all of the information transmission means are operational, the network then allows a complete circulation of the information in both circulation directions of the messages on the network.

Thus, for example, and in the event said network is made up of nodes connected in a closed loop, the network can then be likened to logic rings in which messages circulate.

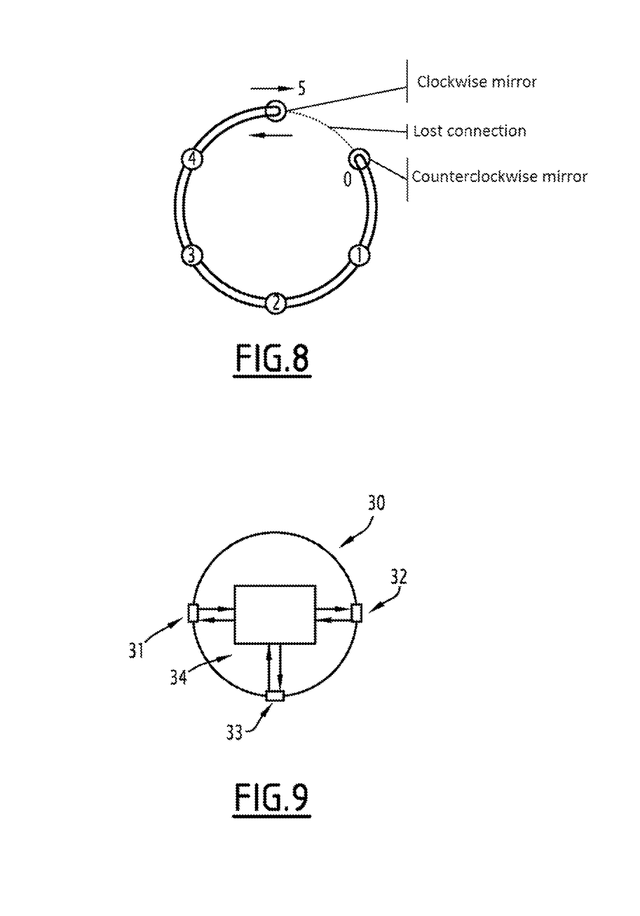

In the event one of the means for transmitting information between two neighboring nodes is lost, as illustrated in FIG. 8, the communication topology is modified to form a single ring.

In that case, the end nodes of the branch thus formed are suitable for operating in the mirror mode for returning information to the neighboring transmitting node.

This is then done by controlling the corresponding ports of those nodes using the corresponding communication automaton-forming means. These automaton-forming means then detect that malfunction and order switching of the ports into the mirror mode.

As previously indicated, network nodes may also include more than two associated input and output ports, like that illustrated in FIG. 9.

The node shown in that figure, and designated by general reference 30, then for example includes three or more associated ports designated by references 31, 32 and 33, optionally associated with information routing means 34.

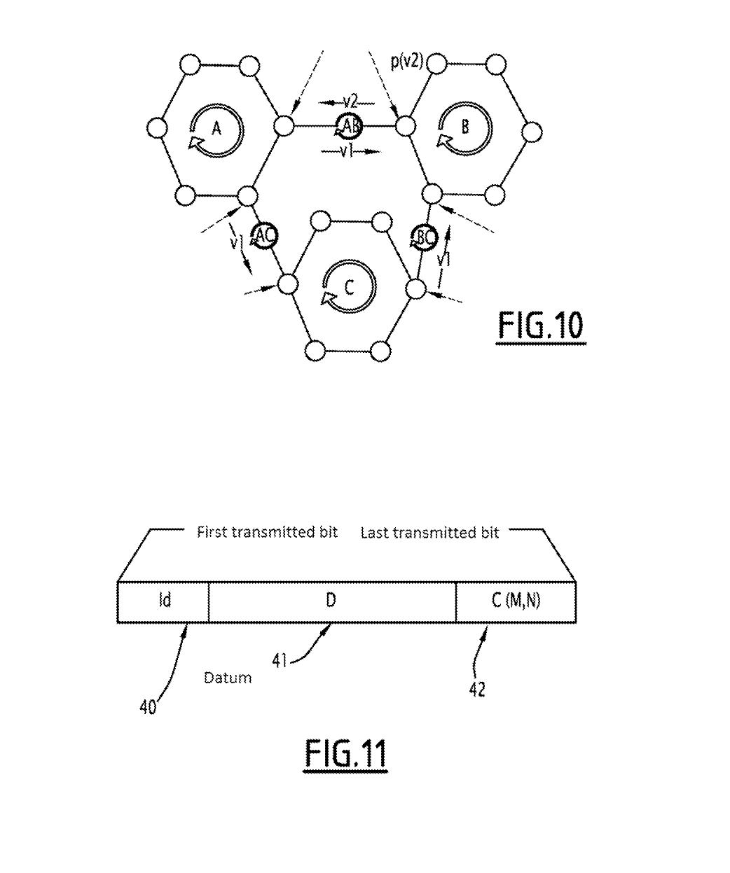

This then makes it possible to multiply the number of possible network configurations with such notes, as illustrated in FIG. 10, where it is shown that nodes may be connected in a closed loop by corresponding information transmission means.

Furthermore, nodes may also be connected by information transmission means in at least one branch whereof the end nodes are suitable for operating in mirror mode for returning information to the neighboring transmitting node, or in connecting branches of other nodes connected in a closed loop by information transmission means.

Of course, still other configurations may be considered.

Lastly, FIG. 11 shows one possible example embodiment of the message format, which traditionally includes a message header 40, data 41, and a control portion designated by general reference 42.

To that end, it may be noted that at least certain nodes may also include means for generating error information intended to be transmitted in case of non-reception of valid information from a neighboring node within a predetermined length of time.

Likewise, at least some of these nodes may also, traditionally in this type of application, include means for generating service information intended to be transmitted on the network.

Of course, still other embodiments may be considered.

1. An information transmission network, comprising:
functional nodes connected in series by information transmission devices, in which the information assumes the form of discrete messages propagating from node to node in the network, wherein:
the information transmission devices between the nodes are bidirectional to allow information to propagate in both circulation directions of the network,
each node comprises at least one of a first and a second associated information input/output port, connected by corresponding information transmission device to neighboring nodes and the operation of which is controlled exclusively and sequentially, by a communication automaton, between a mode of operation with asynchronous reception of information from its neighboring nodes and a mode of operation for synchronous transmission of information to its neighboring nodes.

2. The information transmission network according to claim 1, wherein the communication automaton is suitable for switching the associated ports of the node from their reception operating mode to their transmission operating mode, after, for each of them:
either receiving valid information,
or the expiration of a predetermined period of time for non-reception of valid information.

3. The information transmission network according to claim 2, wherein the communication automaton is suitable for switching each of the associated ports in return, from its transmission operating mode to its reception operating mode, after the end of transmission of the information by the port.

4. The information transmission network according to claim 1, wherein the ports associated with each node are connected to a buffer-forming device using first in-first out logic.

5. The information transmission network according to claim 1, wherein the nodes include more than two associated input/output ports.

6. The information transmission network according to claim 1, wherein the nodes are connected in a closed loop using the information transmission devices.

7. The information transmission network according to claim 1, wherein the nodes are connected by the information transmission devices, in at least one branch whereof the end nodes are suitable for operating in a mirror mode for returning information to the transmitting neighboring node.

8. The information transmission network according to claim 1, wherein the nodes are connected by the information transmission devices, in a connecting branch of other nodes connected in the closed loop by the information transmission devices.

9. The information transmission network according to claim 1, wherein each node is suitable for switching into the mirror operating mode for returning information to a neighboring transmitting node in the event a malfunction is detected.

10. The information transmission network according to claim 1, wherein at least some of the nodes comprise a generating service information unit generating service information intended to be transmitted over the network.

11. The information transmission network according to claim 1, wherein at least some of the nodes comprise a generating error information unit generating error information intended to be transmitted in case of non-reception of valid information from a neighboring node within a predetermined period of time.

12. The information transmission network according to claim 1, wherein the information transmission devices include a wired connection.

13. The information transmission network according to claim 12, wherein the information transmission devices comprise pairs of twisted wires.

14. The information transmission network according to claim 12, wherein the information transmission devices include coaxial cables.

15. The information transmission network according to claim 1, wherein the information transmission devices include optical fibers.

16. The information transmission network according to claim 1, wherein the information transmission devices include wireless connections.

17. An information transmission network node intended for a network according to claim 1.
